(19) United States
(12) Patent Application Publication
(10) Pub. No.: US 2021/0087082 A1
(43) Pub. Date: Mar. 25, 2021

(54) ELECTROGENERATION OF REACTIVE OXYGEN SPECIES WITHOUT EXTERNAL OXYGEN SUPPLY

(71) Applicant: Northeastern University, Boston, MA (US)

(72) Inventors: Yuwei Zhao, Boston, MA (US); Ljiljana Rajic, Amherst, MA (US); Akram Alshawabkeh, Franklin, MA (US)

(21) Appl. No.: 17/029,643

(22) Filed: Sep. 23, 2020

Related U.S. Application Data
(60) Provisional application No. 62/904,194, filed on Sep. 23, 2019.

(51) Int. Cl. C02F 1/461; C02F 1/467

(52) U.S. Cl. CPC C02F 1/46109; C02F 1/4672; C02F 2001/46133; C02F 2001/46119; C02F 2101/308; C02F 2303/16; C02F 2305/023; C02F 2305/026; C02F 2001/46166

(57) ABSTRACT

Disclosed is a method of removal of an organic pollutant from an aqueous solution, comprising: a) contacting the solution with an anode and a cathode comprising a carbon material; b) applying electrical current to the anode, thereby generating reactive oxygen species; b) oxidizing the organic pollutant with the reactive oxygen species; and c) regenerating the carbon material. Also disclosed is a method of producing reactive oxygen species, comprising: a) flowing an aqeous solution through a reactor comprising at least one cathode and at least one anode; b) applying electrical current to the at least one anode; and c) collecting a product solution comprising reactive oxygen species.

### RELATED APPLICATIONS

This application claims the benefit of priority to U.S. Provisional Patent Application No. 62/904,194, filed on Sep. 23, 2019.

### GOVERNMENT SUPPORT

This invention was made with government support under Grant No. 1129433 awarded by the National Science Foundation and Grant No. ES017198 awarded by the National Institutes of Health. The government has certain rights in the invention.

### BACKGROUND

Granular activated carbon (GAC) has long been extensively used in water treatment for adsorption of various pollutants (e.g., organic contaminants and heavy metals). However, the economic competitiveness of the process depends on the reusability of exhausted carbon. Among various regeneration techniques, thermal regeneration is the most widely used one and has been applied to regenerate spent GAC at industrial scale. However, the process requires high temperature and suffers 5-15% carbon loss due to oxidation and attrition. Thus, alternative approaches such as wet oxidation, microwave, Fenton oxidation, dielectric barrier discharge method, and electrochemical method have been explored to propose an efficient and cost-attractive technology to regenerate spent GAC. Among these, electrochemical based methods constitute a promising option due to the unique features such as low temperature operation, no addition of chemicals and in situ cracking of organics deposited on GAC without damaging the textural characteristics of carbon. Therefore, an efficient electrochemical process for saturated GAC regeneration would be of high value.

Carbon materials based on renewable carbon sources, such as biochar, are an attractive option for use in absorption and decomposition of pollutants. Biochar, a low-cost carbon-rich material derived from a wide variety of biomass, such as sawdust, rice husk, manure, corn residual, and bean straw, via pyrolysis with limited oxygen or hydrothermal carbonization under high pressure, has attractive properties including relatively large surface area, high pore volume, high stability, and enriched surface functional groups. It poses great potential in adsorption, catalysis, gas separation, and energy storage. Most recently, several types of biochar have been used as electrode materials in microbial fuel cell and supercapacitors. Principally, as a carbon-rich material, biochar should has the ability on 2-electron O₂ reduction for H₂O₂ generation. Biochar has not been previously evaluated as cathode material in the Electro-Fenton (EF) process, which is known as one of the promising electrochemical advanced oxidation processes (EAOPs) for the treatment of wastewaters containing several families of persistent and toxic organic pollutants. Moreover, biochar can effectively activate H₂O₂ for OH^{⋅} generation. This indicates that an EF process enabled by biochar cathode could achieve simultaneous H₂O₂ electrogeneration and activation without iron catalysts.

Oxidation of pollutants requires presence of oxidants, such as reactive oxygen species (ROS). ROS are defined as a group of reactive molecules and free radicals derived from molecular oxygen, such as superoxide (O₂⁻), hydroxyl (OH^{⋅}), hydrogen peroxide (H₂O₂), and ozone (O₃). They are widely used in industry and environmental protection because of their strong oxidizing ability. H₂O₂, which has relatively good stability in the environment, is commercially produced in large quantities, and extensively used for disinfection, pulp and paper bleaching (U.S. Pat. No. 2,371,545; incorporated by reference), wastewater treatment, chemical synthesis, groundwater remediation, etc. With the EF reaction H₂O₂ can be easily converted into hydroxyl radicals, which are even stronger oxidizing agents. The only degradation product of its use is water. Thus, it has played an important role in environmentally friendly methods in the chemical industry.

Anthraquinone oxidation (AO) process is by far the most applied technology for the production of H₂O₂. The process accounts for 95% of worldwide H₂O₂ production. In this process, alkylanthraquinone precursor is hydrogenated and oxidized sequentially, then H₂O₂ can be recovered by liquid-liquid extraction. However, this method can hardly be considered a green method, because it requires high energy input and can generate waste, which has an adverse effect on its sustainability and production cost. Other significant problems associated with the AO process are potential for explosive reactions (i.e., safety concerns with hydrogen and oxygen reaction).

The principal alternative approach for H₂O₂ production is through a conventional electrochemical process. Compared to the chemical process, electrochemical production has fewer unwanted by-products, higher purity, greater safety and fewer environmental concerns. The oxygen reduction reaction (ORR) is commonly used for H₂O₂ electrochemical generation as shown in equation 1. The efficiency of the oxygen reduction reaction is highly dependent on cathode materials. Several materials, such as graphite, graphite felt, carbon-polytetrafluoroethylene (PTFE), graphite PTFE, activated carbon fiber, carbon sponge, reticulated vitreous carbon (RVC), stainless steel, titanium, and gas diffusion electrode, are used in the EF process. Particularly, gas diffusion electrodes (GDEs) have attracted significant attention because of their excellent performance in H₂O₂ production. A GDE has a thin and porous hydrophobic structure favoring the percolation of the injected gas across its pores to contact the solution at the carbon surface, and a large number of active surface sites leading to a very efficient O₂ reduction and large accumulation of H₂O₂. For example, Bunn et al. (U.S. Pat. No. 8,377,384; incorporated by reference), Vanden et al. (U.S. Pat. No. 7,604,719; incorporated by reference), and Gopal (U.S. Pat. No. 6,712,949; incorporated by reference) designed different equipment for hydrogen peroxide generation by using gas diffusion electrode with external oxygen supply. However, by using GDE, external O₂ supply is required, and some designs need pH adjustment as the pretreatment (see U.S. Pat. Nos. 3,856,640, and 5,358,609; both incorporated by reference). These all increase the cost, lower the safety factor, and limit the application of the design. Besides, all of the designs produce H₂O₂ in a batch reactor. It cannot regularly provide H₂O₂ for utility.

O₂+2H⁺+2e⁻→H₂O₂ (1)

Therefore, it is desirable to provide a more convenient method to produce hydrogen peroxide constantly and steadily without external O₂ supply and pretreatment, which is suitable for scaling up for in a large manufacturing installation, as well as for smaller on-site peroxide generation.

### SUMMARY

In some embodiments, the present disclosure relates to a method of removal of an organic pollutant from an aqueous solution, comprising:

a) contacting the aqueous solution with an anode and a cathode comprising a carbon material;
b) applying electrical current to the anode, thereby generating reactive oxygen species;
b) oxidizing the organic pollutant with the reactive oxygen species; and
c) regenerating the carbon material.

In some embodiments, the present disclosure relates to a method of producing reactive oxygen species, comprising:

a) flowing a precursor solution through a reactor comprising at least one cathode and at least one anode;
b) applying electrical current to the at least one anode; and
c) collecting a product solution comprising reactive oxygen species.

### BRIEF DESCRIPTION OF THE DRAWINGS

FIG. 1 shows a schematic illustration of the setup for dye-loaded GAC regeneration.

FIG. 2 shows a plot demonstrating the effect of regeneration time on regeneration efficiency (RE) and total organic carbon (TOC) removal: regeneration time 0.5 h.

FIG. 3 shows a plot demonstrating the effect of regeneration time on RE and TOC removal: regeneration time 1.5 hrs.

FIG. 4 shows a plot demonstrating the effect of regeneration time on RE and TOC removal: regeneration time 12 hrs.

FIG. 5 shows a plot demonstrating the electrolyte TOC after 12 h regeneration and calculated TOC of RB19 adsorbed on GAC.

FIG. 6 shows a plot demonstrating conductivity of electrolyte after 12 h over 10 regeneration cycles. Conditions: 1.5 g GAC, 180 mL, 50 mM Na₂SO₄, 100 mA, 350 rpm, neutral initial pH.

FIG. 7 shows a plot demonstrating H₂O₂ electrogeneration by a cathode consisting of a 50×50 stainless steel mesh bag GAC (GACSS cathode) using virgin GAC and GAC regenerated after 10 cycles with a regeneration time of 12 h.

FIG. 8 shows a plot demonstrating H₂O₂ activation by virgin GAC, RB19-loaded GAC, and GAC regenerated after 10 cycles with a regeneration time of 12 h.

FIG. 9 shows profile of fluorescence intensity at 410 nm by using virgin GAC, RB19-loaded GAC, and GAC regenerated after 10 cycles with a regeneration time of 12 h. Conditions: 1.5 g GAC, 180 mL, 50 mM Na₂SO₄ (for a), 100 mA (for a), c(H₂O₂)=1 mM, c(BA)=20 mM, 350 rpm, neutral initial pH, excitation wavelength: 303 nm.

FIG. 10 shows N₂ isotherms (top) and pore size distribution (bottom) of virgin GAC and GAC regenerated under different regeneration time and after different numbers of cycles (GAC-X-Y labels refer to GAC samples regenerated after Y cycles with a regeneration time of X h).

FIG. 11 shows a schematic illustration of the mechanism of “self-cleaning” electrochemical regeneration of dye-loaded GAC.

FIG. 12 shows SEM images of as-prepared bamboo biochar: end view (top) and top view (bottom).

FIG. 13 shows an XRD pattern (top) and Raman spectrum (bottom) of as-prepared bamboo biochar.

FIG. 14 shows XPS spectra of as-prepared bamboo biochar: XPS survey spectrum (top) and high-resolution XPS spectra of C1s (bottom)

FIG. 15 FTIR spectrum (top) and N₂ adsorption-desorption isotherm and the corresponding pore-size distribution (inset) (bottom) of as-prepared bamboo biochar.

FIG. 16 shows a plot demonstrating the effect of current intensity on H₂O₂ generation by a cathode consisting of bamboo biochar (BB) and stainless steel (SS) mesh (denoted as BBSS cathode). Conditions for H₂O₂ production: 180 mL, 50 mM Na₂SO₄, 350 rpm, 2.0 g BB, neutral pH.

FIG. 17 shows a plot demonstrating the effect of BB modification on H₂O₂ generation by BBSS cathode. Conditions for BB modification: 180 mL, 50 mM Na₂SO₄, 2.0 g BB, neutral pH, constant current of 200 mA for 30 min. Conditions for H₂O₂ production: 180 mL, 50 mM Na₂SO₄, 350 rpm, 2.0 g BB, neutral pH, 50 mA.

FIG. 18 shows a plot demonstrating the effect of pH on H₂O₂ generation by BBSS cathode. Conditions for H₂O₂ production: 180 mL, 50 mM Na₂SO₄, 350 rpm, 2.0 g BB, 50 mA.

FIG. 19 shows plots demonstrating H₂O₂ activation by BB: catalytic H₂O₂ decomposition (top); hydroxyl radicals generation under neutral and acidic pH using fluorescence method (bottom), conditions: 180 mL, 350 rpm, 2.0 g BB, c(H₂O₂)=0.5 mM, c(benzoic acid)=10 mM, without current, room temperature.

FIG. 20 shows plots demonstrating degradation of RB19, Orange II, and 4-NP by EF process enabled by BBSS cathode: UV-Vis spectra of RB19 solution with an initial concentration of 25 μM (top); change of normalized RB19 concentration for various RB19 initial concentrations (bottom).

FIG. 21 shows plots demonstrating degradation of RB19, Orange II, and 4-NP by an EF process enabled by BBSS cathode: UV-Vis spectra, normalized concentration of Orange II, and TOC removal efficiency of Orange II (top); and UV-Vis spectra, normalized concentration of 4-NP, and TOC removal efficiency of 4-NP (bottom). Conditions: 180 mL, 50 mM Na₂SO₄, neutral pH, 2.0 g BB, 350 rpm, 100 mA, c(Orange II)=50 μM, c(4-NP)=20 μM.

FIG. 22 shows a plot demonstrating TOC removal efficiency of RB19 solution by EF process enabled by BBSS cathode with an initial concentration of 50 μM.

FIG. 23 shows a plot demonstrating reusability of BBSS electrode through comparison of H₂O₂ production (top), RB19 removal (bottom), and H₂O₂ activation, and OH^{⋅} generation (inset in bottom) by fresh BBSS electrode and BBSS electrode used for 30 cycles. Conditions: 180 mL, 50 mM Na₂SO₄, pH of 7, 2.0 g BB, 350 rpm.

FIG. 24 shows a plot demonstrating H₂O₂ production by various cathodes under 0.19 cm/min at 120 mA.

FIG. 25 shows a plot demonstrating the effect of volume ratio of PTFE to water on the yield of H₂O₂ under 0.19 cm/min at 90 mA.

FIG. 26 shows a plot demonstrating the effect of current on H₂O₂ production (0.19 cm/min).

FIG. 27 shows a plot demonstrating the effect pulse current on H₂O₂ production (0.19 cm/min).

FIG. 28 shows a plot demonstrating the effect of three-electrode system on H₂O₂ production (0.19 cm/min).

FIG. 29 shows a schematic representation of a biochar-based electrode composed with granular biochar and SS mesh bag (1-SS mesh, 2-granular biochar).

FIG. 30 shows a schematic representation of a reactor used for generation of reactive oxygen species and organic pollutants degradation (1-DC power supply, 2-wire, 3-Na2SO4 supporting electrolyte, 4-biochar-based cathode, 5-magnetic stirrer bar, 6-Ti/MMO anode, 7-batch reactor).

FIG. 31 shows a schematic illustration of the fabrication process of biochar-based cathode and the subsequent electrochemical process for reactive oxygen species generation and organic pollutants degradation.

FIG. 32 shows a schematic illustration of the “self-cleaning” electrochemical regeneration of saturated granular activated carbon.

### DETAILED DESCRIPTION

GAC electrochemical regeneration is a process that has been previously explored. Regeneration efficiency (RE) of phenol-saturated GAC of 85.2% can be achieved by using it as an electrode to accelerate the electrooxidation of phenol. However, GAC surface could be oxidized which limits its adsorption capacity in consecutive cycles. An electro-peroxone process (a combined process of ozonation and in situ cathodic H₂O₂ production) has been proposed to regenerate Rhodamine B dye saturated powdered activated carbon (PAC), and more than 90% of the adsorption capacity of PAC was restored. A semi-batch electrochemical reactor was used by filling organic compounds saturated GAC between SnO₂/Ti anodes and stainless steel mesh cathodes, the RE is more than 90% even after regenerating for 10 cycles under optimal conditions. However, considering the conductive nature of GAC, it could become a bipolar electrode in electric field, which inevitably results in oxidation-related changes of the GAC surface structure. To overcome this drawback, an electro-Fenton based method to regenerate GAC saturated by toluene has been reported. H₂O₂ was electrogenerated on negatively polarized GAC, Fe²⁺ was supplied by Fe-loaded ion-exchange resin. The regeneration only reduced by 1% per cycle during 10 consecutive cycles. More recently, the effectiveness of electro-Fenton process on the regeneration of AC and AC carbon fiber has been demonstrated. Nevertheless, GAC itself has been confirmed to be a suitable catalyst for the selective decomposition of H₂O₂ to OH^{⋅}, which could potentially replace Fe²⁺ and avoids the forming and handling of iron sludge. Additionally, one possible drawback of electro-Fenton regeneration which used negatively polarized carbon adsorbent is that the hydroxyl radicals, which are responsible for organics destruction, distributed uniformly in bulk solution. However, the organics majorly existed on adsorbent vicinity, causing a low utilization efficiency of hydroxyl radicals.

The present disclosure provides a novel electrochemical process that supports saturated GAC “self-cleaning” by simultaneous H₂O₂ electrogeneration and activation under neutral pH. Ti/mixed metal oxides (Ti/MMO) anode was used to in situ supply O₂, stainless steel (SS) mesh bag packed with saturated GAC was used as cathode, which has two functions, that is, H₂O₂ electrogeneration via dissolved O₂ reduction reaction (ORR) and OH^{⋅} generation via H₂O₂ activation. The advantages of “self-cleaning” strategy includes: (1) H₂O₂ is electrogenerated via anodic O₂, which avoids the external addition of H₂O₂; (2) H₂O₂ was catalytically decomposed upon GAC into OH^{⋅}, the use of Fe²⁺ is avoided; (3) GAC is part of the cathode, which induces the protection of carbon surface.

Electro-Fenton (EF) system, developed in the 2000s, is known as one of the promising electrochemical advanced oxidation processes (EAOPs) for the treatment of wastewaters containing several families of persistent and toxic organic pollutants. It involves the in situ H₂O₂ electrogeneration via 2-electron reduction of dissolved O² in acidic medium (Eq. 2) and the continuous regeneration of Fe²⁺ (Eq. 3). H₂O₂ reacts with Fe²⁺ to form highly oxidative, non-selective hydroxyl radicals (Eq. 4) for pollutants destruction

O₂+2H⁺+2e⁻→H₂O₂ (2)

Fe³⁺+e⁻→Fe²⁺ (3)

H₂O+Fe²⁺→Fe³⁺+OH^{⋅}+OH⁻ (4)

The effectiveness of the EF process is highly dependent on H₂O₂ yield. To achieve a high yield of H₂O₂, various types of materials have been evaluated, including graphite felt (GF), carbon felt (CF), reticulated vitreous carbon (RVC) foam, graphene/CF, carbon nanotubes/graphite, acetylene black/PTFE, carbon black/polytetrafluoroethylene (PTFE)/GF, and gas diffusion electrode (GDE). Usually, the O₂ was supplied by sparging of pure O₂ or air to the cathode surface. However, the O₂ utilization is extremely low (<0.1%) and could be a major energy waste in a production process. Besides, the structure of a high-performance cathode is usually complex, which requires several fabrication steps and has low mechanical stability. Another drawback of the EF process is that the Fe²⁺ addition and pH adjustments (i.e. acidification and neutralization before and after treatment) complicate the operation process and increase the cost. Thus, it is highly desirable to develop a cost-effective EF process using low-cost cathode materials that could achieve simultaneous H₂O₂ electrogeneration and H₂O₂ activation without Fe²⁺ and aeration conditions.

In some embodiments, the present disclosure relates to a cathode configuration consists of bamboo biochar (BB) and stainless steel (SS) mesh (denoted as BBSS electrode). The BB was wrapped by SS mesh so that the SS mesh distributes the current and BB functions as catalysts for simultaneous H₂O₂ generation and activation. Binders are avoided in this design. In this work, the effect of current intensity, solution pH on H₂O₂ yield, as well as catalytic H₂O₂ decomposition and OH^{⋅} generation by BBSS composite electrode were systematically investigated. Moreover, a simple electrochemical method was used to modify BB to examine whether oxidative modification could further improve its activity of BB on H₂O₂ production and activation. Additionally, EF-like process enabled by BBSS cathode without Fe²⁺ addition and external aeration was tested for various organic pollutants (Reactive blue 19, Orange II, 4-nitrophenol) degradation. Finally, the long-term stability of BBSS electrode on H₂O₂ electrogeneration, H₂O₂ activation, OH^{⋅} generation, and pollutants degradation were tested.

### Effect of Regeneration Time

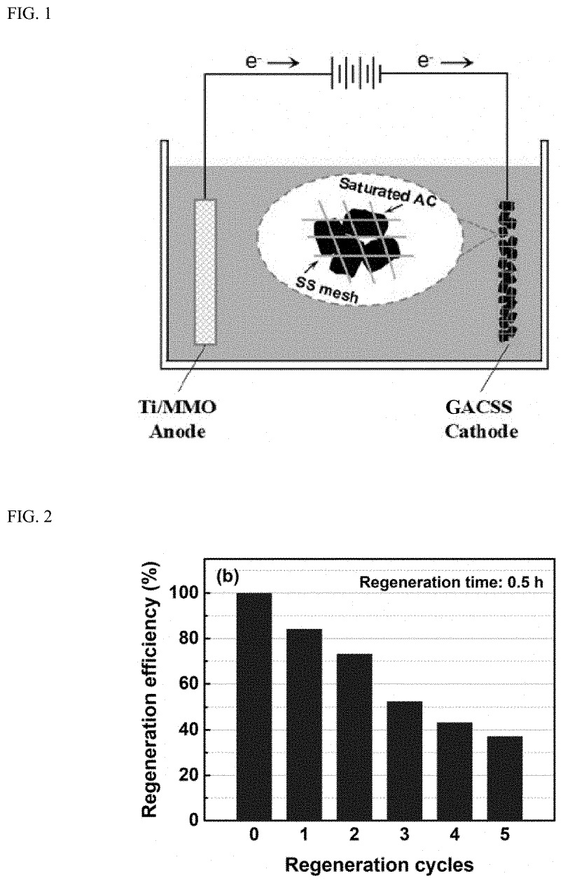

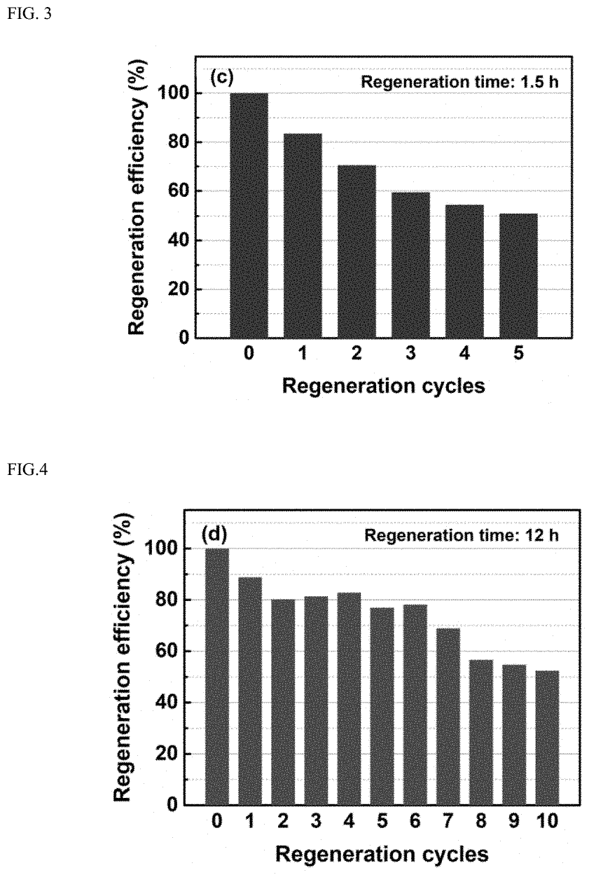

To examine the effectiveness of the proposed “self-cleaning” concept, RB19-loaded GAC was regenerated under different times (e.g., 0.5 h, 1.5 h, and 12 h). Continuous adsorption-regeneration cycles were also conducted to evaluate the cycling performance of the proposed method. The application of Ti/MMO anode supplies O₂ via oxygen evolution reaction (OER), while GACSS cathode enables the in situ H₂O₂ generation through O₂ electroreduction and the subsequent H₂O₂ activation, thus avoids the external addition of chemicals such as O₂, H₂O₂, and Fe²⁺ (FIG. 1). As observed in FIGS. 2-3, RE of 84.1%, 83.4%, and 88.7% were obtained under regeneration time of 0.5 h, 1.5 h, and 12 h, respectively, which demonstrated the effectiveness of the proposed method. However, after 5 adsorption-regeneration cycles, regeneration time of 0.5 h resulted in a RE lower than 50%, while regeneration time of 1.5 h showed a slightly higher RE after 5 cycles. What is worth highlighting is that the regeneration time of 12 h resulted in an improved cycling performance. RE of 52.3% was obtained even after 10 cycles (FIG. 4). These results are in accordance with other electrochemical methods, where it was proposed that longer regeneration time usually resulted in a higher RE.

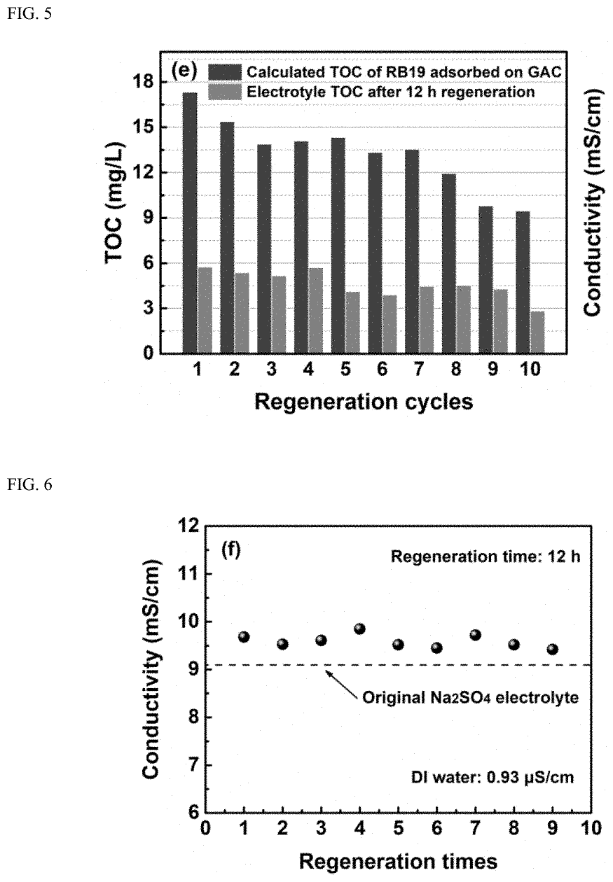

Unexpectedly, cracking of organic contaminants was observed by hydroxyl radicals originating from H₂O₂ which is generated and activated by (i.e. GAC) itself. As shown in FIG. 6, during 10 cycles, 56.3%˜71.2% of total organic carbon (TOC) can be removed. Additionally, it was observed that conductivity of the electrolyte after each regeneration cycle was higher than the original conductivity (FIG. 5), which also demonstrated that the proposed regeneration process can cause the cracking of organic contaminants, where small organic acid by-products were formed and amplified the electrolyte conductivity.

H₂O₂ Electrogeneration, H₂O₂ Activation and OH^{⋅} Generation

The disclosed “self-cleaning” strategy takes advantage of the fact that carbon-based materials can electrogenerate H₂O₂ through 2-electron ORR, and moreover, employs the GAC as H₂O₂ activator for OH^{⋅} generation and used for regeneration of dye-loaded GAC. Thus, the investigation of H₂O₂ electrogeneration, H₂O₂ activation, and OH^{⋅} generation by various GAC (virgin, RB19-loaded, regenerated) are essential to reveal the regeneration mechanism.

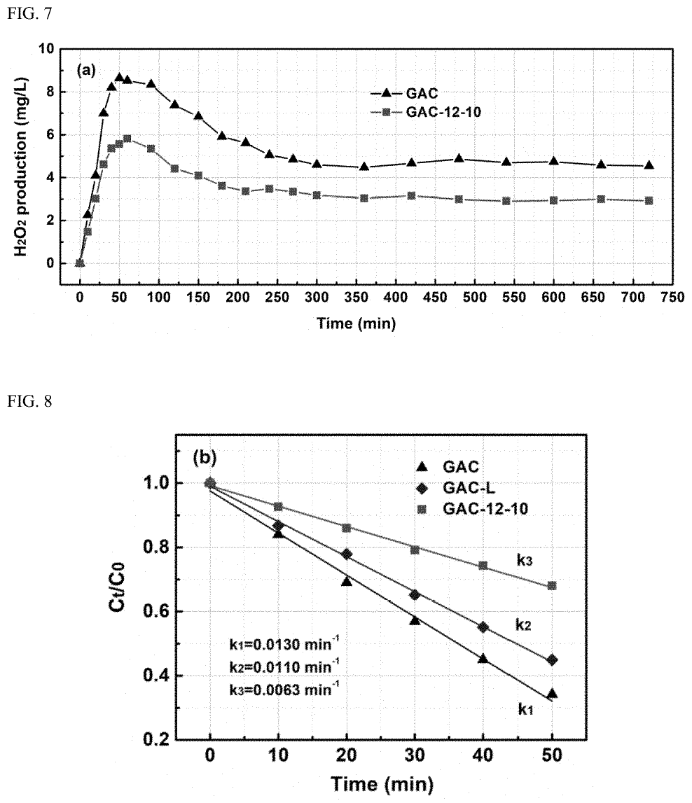

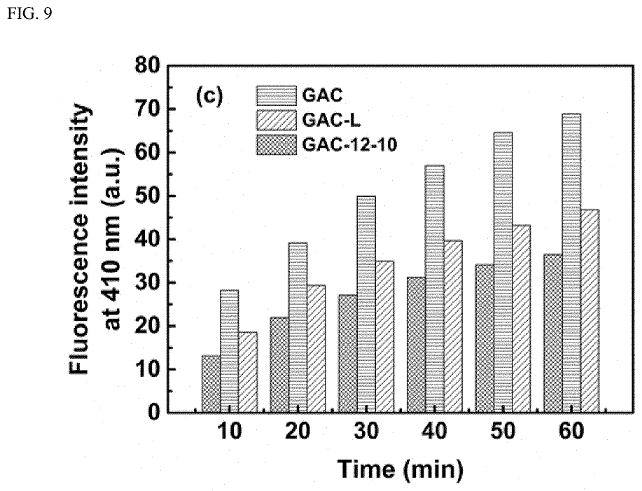

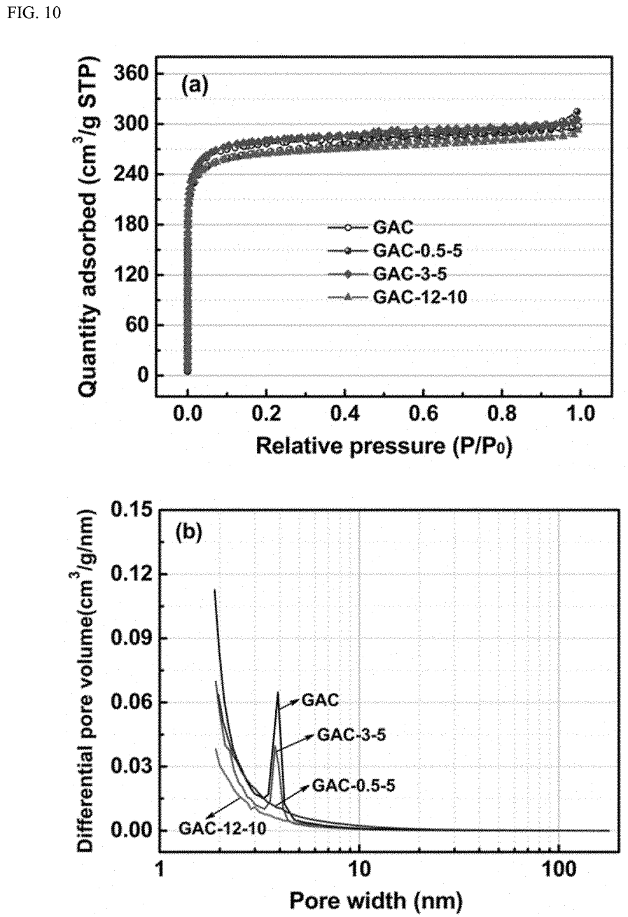

Results in FIG. 7 show the profile of H₂O₂ concentration during a period of 12 h by virgin GAC and GAC-12-10 (GAC regenerated for 12 and operated for 10 adsorption-regeneration cycles). For virgin GAC, up to 8.6 mg/L H₂O₂ was obtained at 50 min and the concentration gradually decreased to 4.6 mg/L and remained relatively stable within 300˜720 min. GAC-12-10 followed the same pattern where up to 5.8 mg/L H₂O₂ was obtained and finally stabilized at around 2.9 mg/L. The result demonstrated that GAC can in situ electrogenerate H₂O₂ as expected. After 10 cycles of regeneration under regeneration time of 12 h, it was still capable for H₂O₂ generation. To assess H₂O₂ activation by various GACs, experiments were conducted without electricity and H₂O₂ was added externally. Results in FIG. 8 clearly shows that H₂O₂ can be effectively decomposed by various GACs. A first-order kinetic constant of 0.0130 min⁻¹, 0.0110 min⁻¹, and 0.0063 min⁻¹ were observed by virgin GAC, RB19-loaded GAC (GAC-L), and GAC-12-10, respectively. Furthermore, by using benzoic acid as OH^{⋅} trapping reagent, fluorescence intensity at 410 nm was monitored (FIG. 9) and results implied that the performance of OH^{⋅} generation followed the sequence of GAC>GAC-L>GAC-12-10, which is in accordance with the percentage of H₂O₂ decomposition in FIG. 8.

### Mechanism of “Self-Cleaning” Electrochemical Regeneration

Based on the above experimental results, a mechanism of the “self-cleaning” electrochemical regeneration was proposed. RB19-loaded GAC was tightly wrapped by SS mesh and GACSS cathode was then used for regeneration operation. O₂ was generated on Ti/MMO anode and transported to cathode vicinity. It was then electroreduced to H₂O₂ both on GAC surface and within porous structure. Due to the catalytic ability of GAC, H₂O₂ within pores and on GAC surface was activated to form highly oxidative OH^{⋅}, which are responsible for the cracking of RB19 and its degradation intermediates, resulting in the GAC regeneration and TOC removal. Apart from this mechanism, the RB19 within pores could also desorbed from GAC due to the increased pH in cathode vicinity.

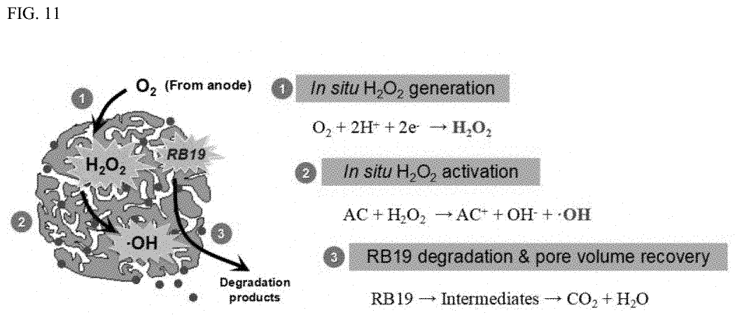

One of the key characteristics of this process is that no oxidants or catalysts were externally added to the system. Both the H₂O₂ electrogeneration and OH^{⋅} generation occurred on the negatively polarized GAC, thus the RB19 molecules, H₂O₂ molecules, and OH⋅ radicals were in the same location (pores and surface of GAC), which facilitated the RB19 cracking by short-lived OH^{⋅} (FIG. 11).

### Characterization of Bamboo Biochar

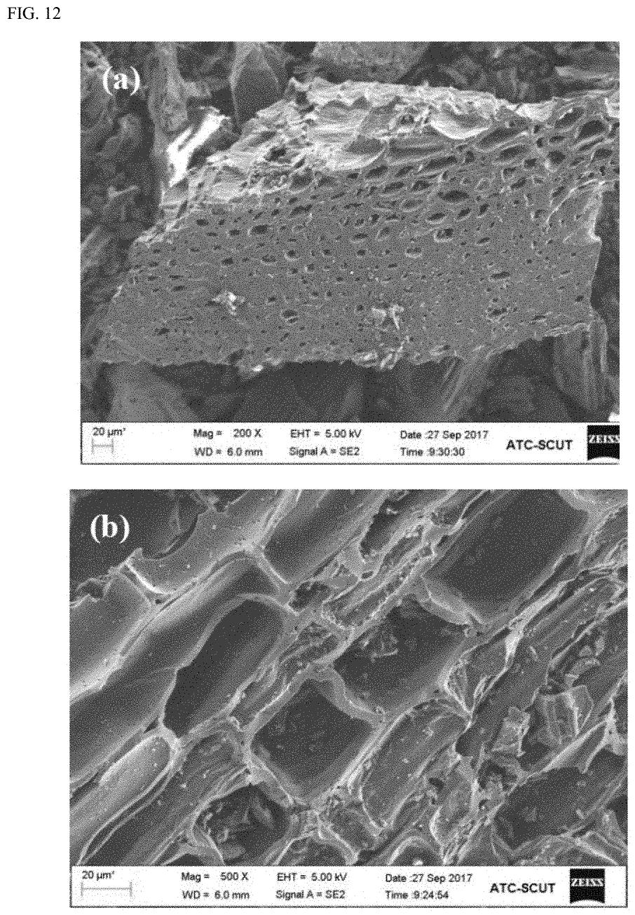

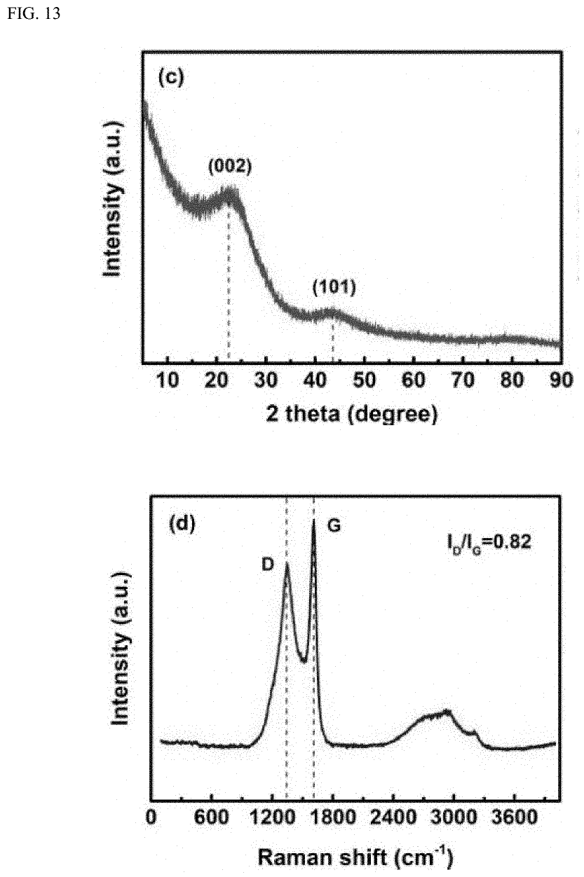

The morphology and micro-structure of the as-prepared bamboo biochar (BB) were characterized by SEM. The SEM images corresponding to its end view and side view are shown in FIG. 12 (top and bottom, respectively). Light regions and black regions correspond to carbon walls and pores, respectively. It can be observed that the original bamboo structure was well retained and abundant pores were generated during the carbonization process. The framework is significant for 2-electron oxygen reduction reaction (ORR) species diffusion/transport, and can expose sufficient electrochemically active sites. XRD and Raman spectroscopy were applied to characterize the graphitization degree of BB sample. Two diffraction peaks appear at 20 values of 23.5 and 44.4 in XRD pattern (FIG. 13, top), which are assigned to typical [002] and [101] reflections of graphitic carbon. The graphitic structure was also characterized by Raman spectroscopy. The spectrum (FIG. 13, bottom) shows two strong peaks at 1350 cm⁻¹ and 1580 cm⁻¹. The peak at 1350 cm⁻¹, ascribed to a D band, belongs to the defect sites or disordered sp²-hybridized carbon, and the peak at 1580 cm⁻¹ was assigned to a G band, corresponding to the phonon mode in-plane vibration of sp²-bonded carbon. Usually, the intensity ratio of D band and G band (ID/IG) is taken as a measure of the crystallization degree or defect density. A ID/IG value of 0.82 was obtained, confirming formation of graphitic carbon. Electronic conductivity is the prerequisite of using BB as an electrode material.

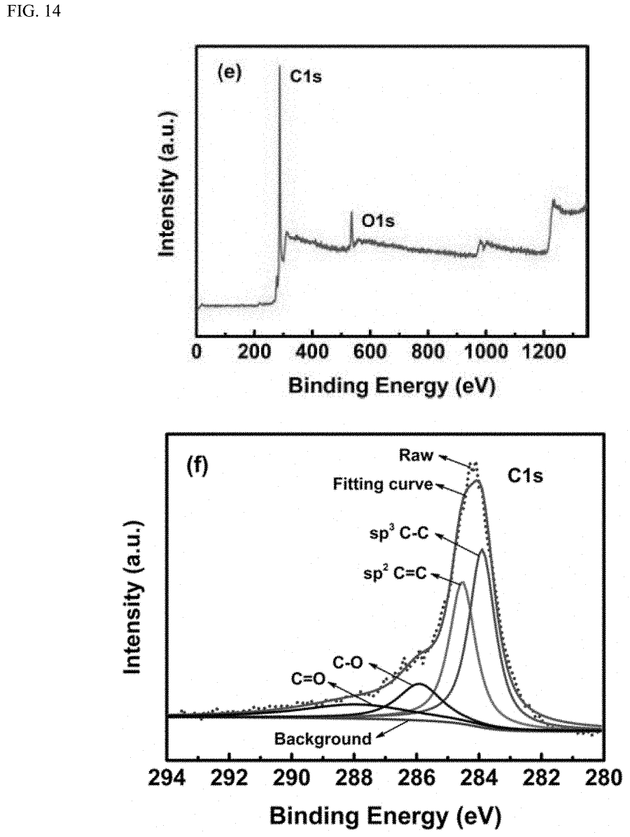

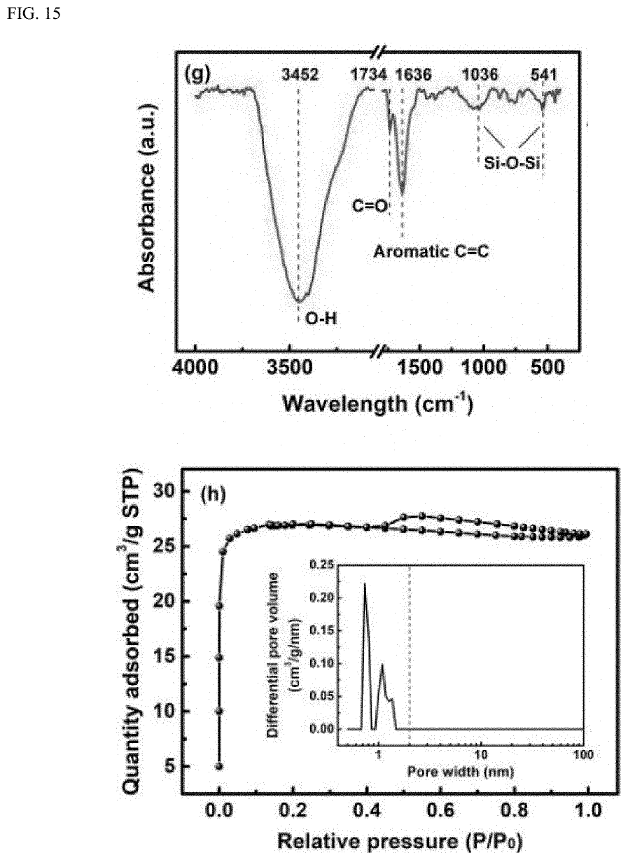

The surface chemical structure was investigated by XPS and FTIR. XPS survey spectra demonstrate that BB contains 0 elements (FIG. 14, top). The C1s XPS spectra, which could be fitted by peaks at 284.6-284.7 eV, 285.1 eV, 286.0-286.3 eV, and 286.8-287.0 eV, were assigned to sp² C═C, sp^{a} C—C, C—OH, and C═O, respectively (FIG. 14, bottom). Previous studies reported that oxygen-containing functional groups (OGs), particularly carboxyl and etheric groups, favor the 2-electron ORR. Thus, the observed OGs on BB surface could be active sites for H₂O₂ electrogeneration. FTIR results further confirmed the above results. In FIG. 15 (top), bands at 3400 cm⁻¹ and 1590 cm⁻¹ were observed, which were assigned to the vibration of hydroxyl group (—OH) and C═0 stretching vibration. The region between 1120 and 1000 cm⁻¹, with an intense band around 1036 cm⁻¹ is assigned to OH vibration of mineral compounds in the BB sample. Elements present on BB surface were also detected by EDX and X-ray mapping of elements. Almost no Fe species were detected on the BB surface.

The surface area and porous structure largely affect the exposed active sites and transport properties of 2-electron ORR species (H⁺/OH⁻, O₂, H₂O, and electrons). N₂ adsorption-desorption isotherm and corresponding pore-size distributions were thus further investigated (FIG. 15, bottom). The BB sample had a BET surface of 80.9 m²/g with the average pore diameter of 1.99 nm. Therefore, BB would should provide abundant active sites for 2-electron ORR due to these well-developed microporous structures.

Performance of the BBSS Electrode on H₂O₂ Generation

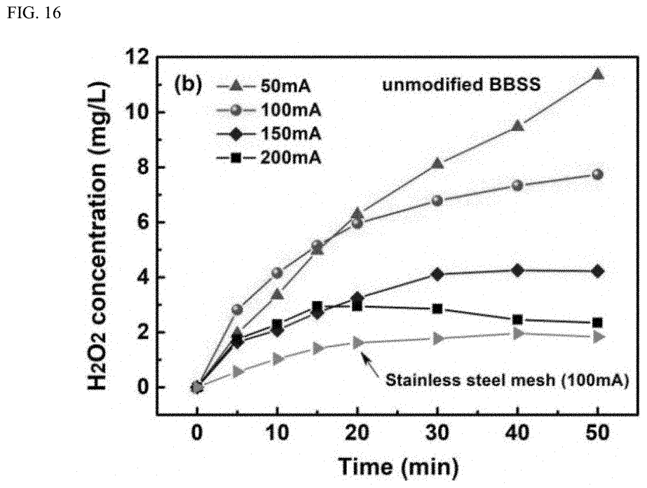

FIGS. 16-18 show the effects of applied current and solution pH on H₂O₂ electrogeneration by as-prepared BBSS cathode. BB has the capability to electrogenerate H₂O₂ via 2-electron ORR. Confirmed by FTIR and XPS tests, the oxygen-containing groups could serve as active sites for 2-electron ORR. 11.3 mg/L H₂O₂ was obtained at 50 min under current of 50 mA, while it is 7.7, 4.2, and 2.3 mg/L for current of 100 mA, 150 mA, and 200 mA, respectively. This shows a further increase of current doesn't necessarily increase the H₂O₂ yield, but instead results in a severe decrease of H₂O₂ yield, which should be ascribed to the several parasitic reactions that leads to H₂O₂ invalid decomposition under high current intensities (Eq. 6-9).

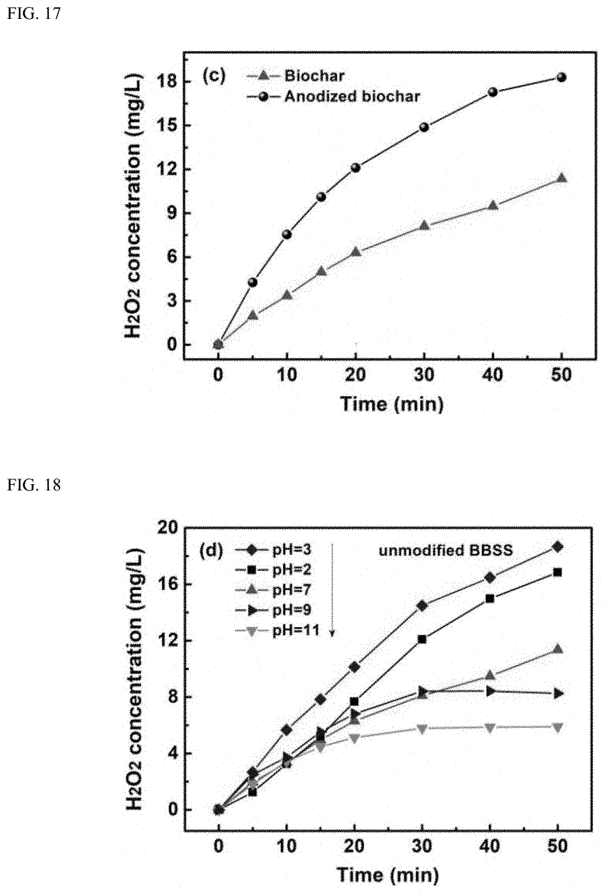

Electrochemical modification of carbonaceous materials could further drastically enhance the H₂O₂ yield of BB cathode. As shown in FIG. 17, 18.3 mg/L was generated by modified BBSS under current of 50 mA, 61.2% higher than the original BBSS cathode. The enhanced performance could be ascribed to the abundant oxygen-containing groups, characterized by NaOH uptake methods. These results demonstrate that BBs H₂O₂-generating ability is comparable and even exceeds that of commonly used cathodes in EF process, such as graphite felt, RVC foam, etc. Considering the broad source and low cost of bamboo biochar, BB cathode is a promising alternative to conventional carbonaceous cathode materials. As can be seen in Table 1, the total cost of a BBSS cathode is about USD $0.82, the main cost of the coming from the SS mesh, energy consumption of pyrolysis, and N₂ gas consumption. The low cost makes it viable with a view at future scale-up.

H₂O₂electrogeneration: O₂+2H⁺+2e⁻→H₂O₂ (5)

Disproportionation: 2H₂O₂→O₂(g)+2H₂O (6)

Cathodic reduction: H₂O₂+2H⁺+2e⁻→2H₂O (7)

Anodic oxidation: H₂O₂→HO₂⋅+H⁺+e⁻ (8)

Anodic oxidation: HO₂⋅→O₂(g)+H⁺+e⁻ (9)

H₂O₂ electrogeneration via Eq. 5 is dependent on the solution pH because of the participation of H⁺ in 2-electron O₂ reduction process. Results in FIG. 18 show the H₂O₂ yield was higher at acidic pH than neutral and alkaline pHs. Up to 18.6 mg/L H₂O₂ was obtained at pH 3, corresponding to a generation rate of 2.0 mg/h/g. However, under pH 2, the H⁺ in solution is 10 times higher than pH 3, the H₂ evolution reaction (HER) can thus be a competing reaction that slightly decreases the H₂O₂ generation. At pH 9 and 11 lower yields were observed, the possible reason being that under high pH, the H⁺ concentration in solution was not high enough to support the effective H₂O₂ generation. The H₂O₂ productivity was calculated and compared with known values as shown in Table 2.

TABLE 1
Cost of BBSS electrode materials and preparation procedure.

| Material | Cost (USD$) |
|---|---|
| Stainless steel mesh | 0.15 |
| Bamboo biochar | ~0.0003 |
| Pyrolysis energy consumption cost | 0.45 |
| N₂ gas cost | 0.22 |

TABLE 2
Comparison of H₂O₂ production rates
using different cathode materials.

| | | Current | | O₂ flow | |
|---|---|---|---|---|---|
| | | density | t | rate | [H₂O₂] |
| Cathode | pH | (A/m²) | (min) | (L/min) | (mg/h/cm²) |
| GDE^{a} | 3 | 204 | 300 | 0.14 | 1.94 |
| Graphite | 3 | −0.65^{b} | 120 | 0.33 | 1.00 |
| Graphite felt | 3 | 132 | 300 | 0.14 | 0.11 |
| (GF) | | | | | |
| Graphite felt | 3 | 50 | 60 | 0 | 0.58 |
| Carbon felt | 3 | 161 | 180 | 0.1 | 0.62 |
| CNTs/ | 3 | 25 | 180 | 2.5^{c} | 0.04 |
| graphite | | | | | |
| Carbon | 7 | 50 | 60 | 0 | 2.35 |
| black/GF | | | | | |
| Activated | 3 | 250 | 180 | 0.1 | 0.55 |
| carbon fiber | | | | | |
| RVC foam | 2 | 167 | 70 | 0 | 0.25 |
| BB^{d} | 7 | 50 mA, | 50 | 0 | 1.22 mg/ |
| | | 2.0 g | | | h/g AC |

^{a}GDE—gas diffusion electrodes;
^{b}the bias potential of the cathode (volts) (vs. the saturated calomel electrode (SCE));
^{c}air aeration;
^{d}this work.

Effective H₂O₂ Activation and OH^{⋅} Generation by BBSS Electrode

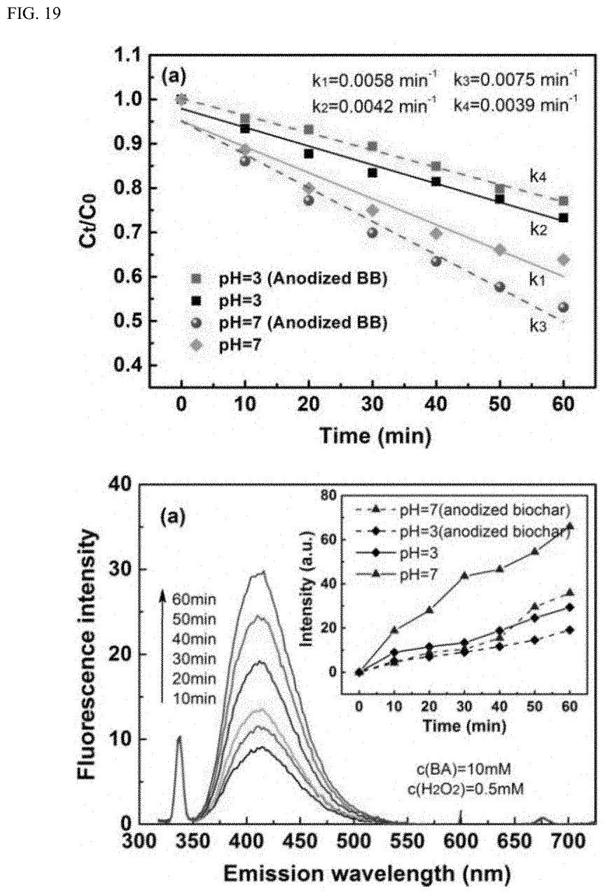

Requirements of Fe²⁺ addition and pH adjustments complicate the operation process and increase the cost of EF process. Herein, the prepared BB was used to test its capability on H₂O₂ activation and OH^{⋅} formation. Interestingly, results in FIG. 19 show that H₂O₂ could be catalytically decomposed by BB, generating highly oxidative OH^{⋅}. This indicates that more H₂O₂ was generated in FIGS. 16-18, due to the partial H₂O₂ decomposition during its electrogeneration. The activation of H₂O₂ by biochar was first reported in 2014. Linear correlations between persistent free radicals (PFRs) in biochar and the trapped OH^{⋅} were observed, thus drawing the conclusion that PFRs induce the 14202 activation.

As FIG. 19 (top) implies, 36.2% 14202 was decomposed after 60 min under pH 7 (k1=0.0058 min⁻¹), while only 26.8% 14202 was decomposed at pH 3 (k2=0.0042 min⁻¹). When using anodized BB as activator, more H₂O₂ (47.0%) was decomposed at pH 7 after 60 min (k3=0.0075 min⁻¹), while less proportion of H₂O₂ (23.0%) was decomposed at pH 3 after 60 min (k3=0.0039 min⁻¹). However, the selectivity towards OH^{⋅} generation is more important because OH^{⋅} is the responsible active species for organic pollutants degradation. Thus, the OH^{⋅} production was evaluated and compared to distinguish the optimal condition for H₂O₂ activation. Results in FIG. 19 (bottom) show that original BB at pH 7 exhibited the highest fluorescence intensity, which indicates the highest amount of OH^{⋅} were generated with original BB under neutral pH. This indicates that H₂O₂ activation, as well as OH^{⋅} generation, could be simultaneously achieved under neutral pH conditions without Fe²⁺ addition. An iron-free EF like process could thus be constructed.

### Pollutants Degradation Performance

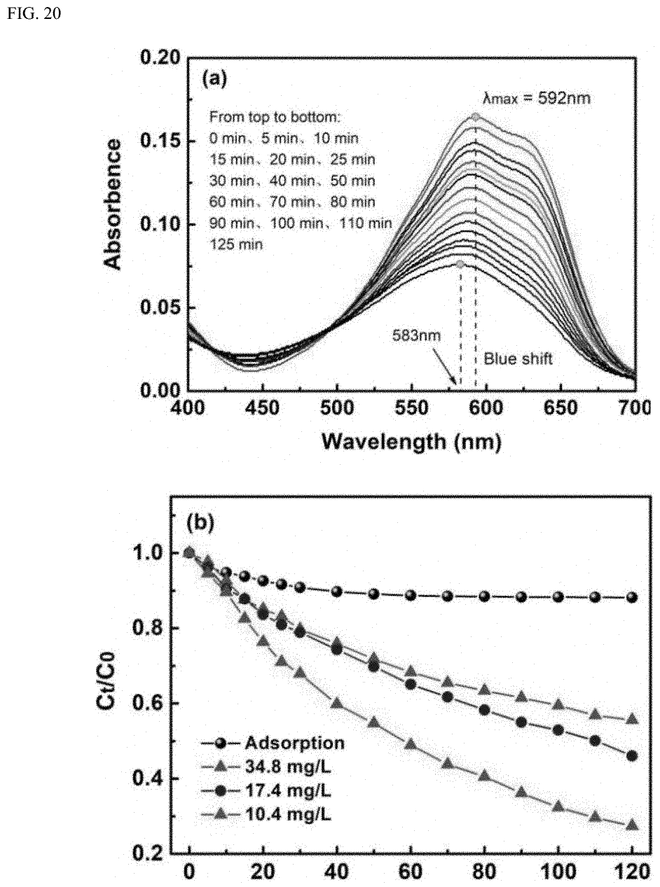

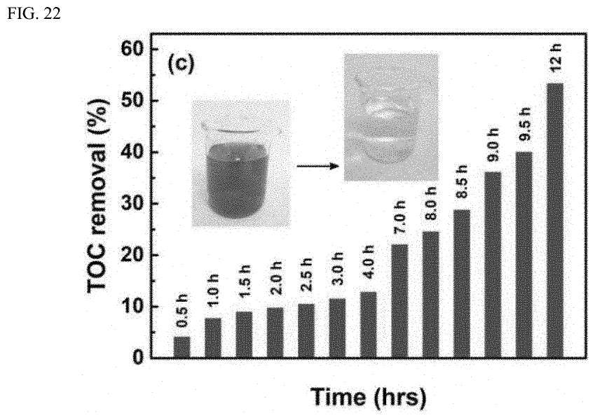

The as-prepared BBSS cathode could be utilized for simultaneous H₂O₂ generation and activation. Thus, EF process supported by BBSS cathode was operated to test its capability on a series of model organic pollutants degradation (RB19, Orange II, and 4-NP) under neutral initial pH. Results shown in FIGS. 20-22 shows the success of this low-cost, iron-free process on organic pollutants removal. The change of UV-Vis spectra of RB19 solution clearly shows that RB19 was gradually removed (FIG. 20, top). The normalized concentration of RB19 was plotted in FIG. 20, bottom, demonstrating that RB19 with various initial concentrations (50 μM, 25 μM, and 15 μM) could be effectively removed. 72.6% RB19 was removed with initial concentration of 15 μM after 120 min electrolysis. The phenomenon that a higher concentration of RB19 results in a lower removal efficiency could be ascribed to the limited kinetics of H₂O₂ generation and activation. FIG. 20, bottom, shows the TOC removal rate within 720 min with an RB19 initial concentration of 50 μM. After 120 min, only 9.9% TOC was removed, while 53.5% TOC was removed after 720 min.

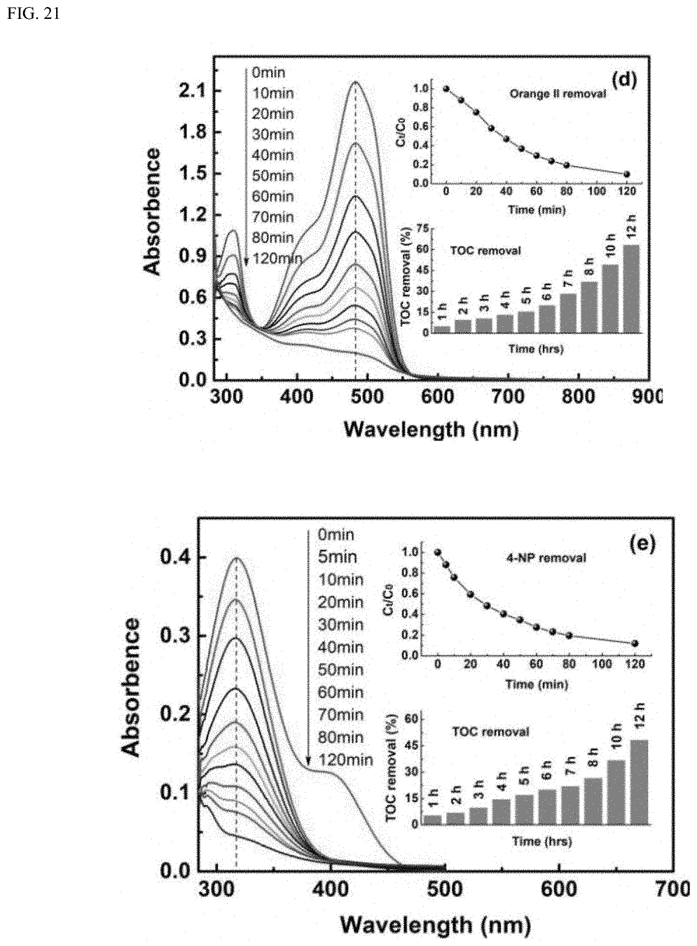

To further confirm the effectiveness of iron-free EF like process enabled by BBSS electrode, Orange II and 4-NP were also employed as model organic pollutants. Profile of UV-Vis spectra, normalized concentration, and TOC removal efficiency of Orange II and 4-NP are shown in FIG. 21. 90.4% Orange II with an initial concentration of 50 μM could be effectively removed after 120 min electrolysis (FIG. 21, top). The TOC removal efficiency gradually increased and achieved 63.5% after 720 min. FIG. 21, bottom, shows that 88.2% 4-NP with an initial concentration of 20 μM was removed after 120 min electrolysis, while the TOC reached 48.4% after 720 min. The TOC removal efficiency is not as fast as most iron-based EF process. However, compared with conventional iron-containing EF process, the system uses low-cost biochar as cathode materials, does not contain iron species and uses a neutral electrolyte. Thus, the cost-effectiveness and environmentally-friendly nature of this iron-free EF like process is highly beneficial.

### Long-Term Stability

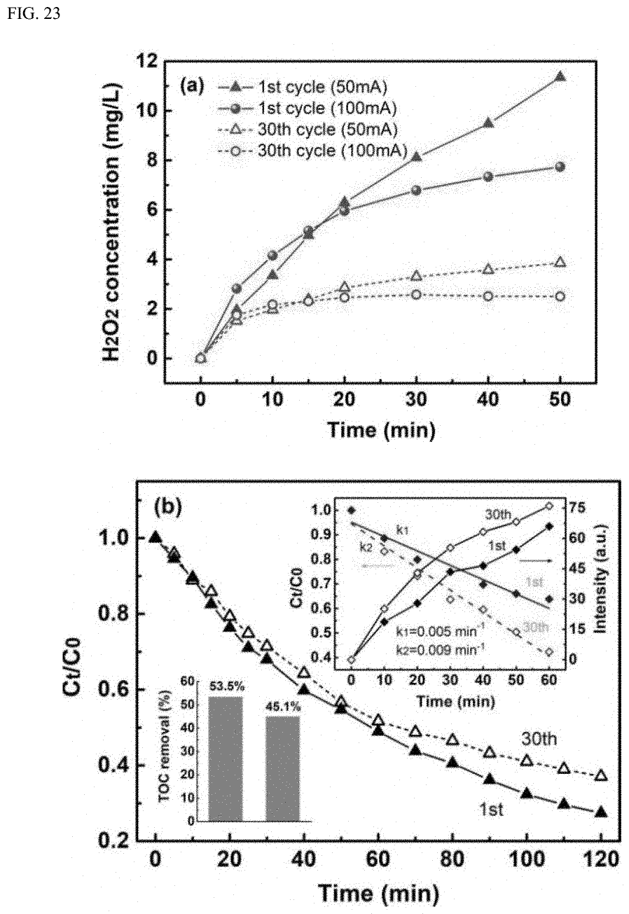

Considering the fact that the EF process is developed for long-term and large-scale environmental remediation applications, the cycling stability of the cathode plays an equal or more important role in determining the performance of EF process. Here, the long-term stability test was conducted to confirm the longevity of the BBSS cathode. After continuous operation of 1500 min (30 cycles), the H₂O₂ electrogeneration, H₂O₂ activation, hydroxyl radical generation, and RB19 degradation performance were tested and compared with the 1^{st} cycle (FIG. 23).

3.9 mg/L and 2.5 mg/L H₂O₂ were obtained by used BBSS electrode under current of 50 mA and 100 mA, respectively (FIG. 23, top). The production is 65.5% and 67.5% lower than the fresh BBSS electrode. Considering the fact that the bamboo biochar is low-cost, its performance on H₂O₂ production after 1500 min is still acceptable. In terms of 14202 activation, the used BB exhibited a first-order kinetics constant of 0.009 min⁻¹ on 14202 decomposition, compared to 0.005 min⁻¹ of the fresh BB (FIG. 23, bottom). An increase in OH^{⋅} generation was also observed.

Additionally, the color and TOC removal of RB19 were compared. RB19 removal efficiency decreased by 13.2% after 120 min (from 72.6% to 63.0%), and TOC removal decreased by 15.1% after 720 min (from 53.5% to 45.1%).

These results suggest that after 1500 min continuous operation, the activity of BBSS electrode on H₂O₂ electrogeneration decrease, but its ability on H₂O₂ activation increase, which results in a relatively stable performance on model organic pollutants degradation compared with the fresh BBSS electrode. It has been reported that a significant amount of unstable surface OGs could be irreversibly removed with reduction using a cathodic potential sweep. Thus, after 1500 min continuous running, the OGs such as the carboxyl groups on biochar are not stable and could be partially removed, which could explain the decrease in 14202 production. Additionally, previous studies suggest that the ability of biochar to perform H₂O₂ activation originates from the PFRs generated from pyrolysis process, and the concentration of PFRs decrease when H₂O₂ was added. After different cathodic polarization time, the rate of H₂O₂ activation by biochar increase. Thus, cathodic polarization of biochar could possibly induce a higher PFRs concentration.

### Environmental Implications

The utility of the EF process majorly depends on the performance and cost of cathode on H₂O₂ production. The disclosed BBSS cathode employs low-cost bamboo biochar and SS mesh as 2-electron ORR catalysts and current distributor, which makes the cathode promising for large-scale applications. The synergistic function of H₂O₂ electrogeneration and activation supports the iron-free EF like process. The activity of BBSS electrode on H₂O₂ production can be further improved by introducing surface OGs to BB by anodic oxidation. Adjusting the BB mass could be another facile method to increase H₂O₂ production. H₂O₂ activation by BB could be increased by introducing basic surface functionalities, as has been documented in the literature.

### Electrochemical Generation of Reactive Oxygen Species by Biomass-Derived Biochar for Wastewater Treatment

In some embodiments, the present disclosure relates to an efficient and low-cost BBSS electrode which supports synergistic H₂O₂ electrogeneration and activation to form OH^{⋅} for various model organic pollutants degradation. Several characterization methods were used to characterize the bamboo biochar. The porous structure, existence of graphitic carbon, and surface OGs make the biochar active in H₂O₂ generation via anodic O₂ electroreduction. Anodization facilitates the 2-electron ORR for H₂O₂ production, which could be a promising modification method to further improve its ability on H₂O₂ generation. In terms of H₂O₂ activation and OH^{⋅} generation, neutral pH supported effective H₂O₂ activation for OH^{⋅} generation. However, the selectivity of H₂O₂ activation for OH^{⋅} generation was significantly inhibited by anodized biochar. The BBSS cathode was then fabricated in an iron-free EF like process to test its effectiveness on degradation of RB19, Orange II, and 4-NP. Results show the system is efficient to remove 72.6%, 90.4%, and 88.2% for RB19, Orange II, and 4-NP after 120 min under initial concentration of 15 μM, 50 μM, and 20 μM, respectively. Moreover, it also achieved partial mineralization of the organic pollutants. Finally, long-term stability of the BBSS electrode was tested. After 1500 min continuous operation, the activity of BBSS electrode on H₂O₂ production decreased. However, its activity on H₂O₂ activation and OH^{⋅} generation unexpectedly increased, which results in a slightly decreased performance on RB19 degradation.

### Summary of the Technology

Reactive oxygen species, such as hydrogen peroxide (14202) and hydroxyl radicals (OH^{⋅}), can be electrochemically generated by low-cost and environmentally-benign biomass-derived granular biochar for wastewater treatment. In this technology, Ti/mixed metal oxides (Ti/MMO) is used as the anode and biochar is used as cathode material. The biochar is active for both H₂O₂ in situ generation from O₂ electroreduction and H₂O₂ activation for OH^{⋅} formation. The Ti/MMO is efficient to supply O₂ for the cathode.

Exemplary Features

(1) For the first time, uses low-cost, environmentally-benign biomass-derived granular biochar for reactive oxygen species generation electrochemically.

(2) The biochar achieves simultaneous H₂O₂ electrogeneration and activation.

(3) The electrochemical process does not require iron addition for H₂O₂ activation.

(4) Neutral pH could support effective H₂O₂ electrogeneration and activation by biochar.

Exemplary Advantages and Improvements over Existing Methods, Devices, or Materials

(1) Compared to commonly used carbon-based cathode materials, such as graphite felt, carbon felt, carbon foam, the biomass-derived biochar is very cheap and environmentally-benign.

(2) Compared with the existing H₂O₂ activation methods, especially the ferrous ions, the biochar does not require acidic conditions and does not cause secondary pollution.

(3) Compared with electro-Fenton process that uses pure O₂ as oxygen source, Ti/MMO could supply O₂ in situ via oxygen evolution reaction.

### Exemplary Commercial Applications

(1) The method to fabricate granular biochar-based cathode can be commercialized and used for organic pollutants degradation in wastewater.

(2) The method to fabricate granular biochar-based cathode has commercial potential for low-concentration H₂O₂ electrogeneration for on-site applications.

### Technical Description

Materials preparation. Fresh bamboo was obtained from a bamboo grove in Guangzhou, China. The bamboo was cut into small pieces (4-8 mesh) and washed with DI water for several times. After drying at 80° C., the bamboo pieces were pyrolyzed in a tubular furnace at 1000° C. for 180 min under the nitrogen atmosphere. Then, the temperature of tubular furnace decreased to 300° C. at 5° C./min until reached the room temperature. The obtained granular bamboo biochar was then rinsed in HCl solution with a concentration of 5 M for 180 min. Before utilization, the granular bamboo biochar was washed with DI water for several times until the pH of solution is near neutral.

Cathode fabrication. A stainless steel (SS) mesh bag (2 cm×4 cm) was prepared and used as current distributor. It was then filled with 2.0 g granular bamboo biochar. The SS mesh bag was tightly filled to guarantee good contact between SS mesh and biochar.

Operation of electrochemical process for organic contaminants degradation. The biochar-based electrode and Ti/MMO electrode was used as cathode and anode, respectively. They were arranged in a batch reactor (volume of 180 mL) horizontally with a distance of 3 cm. Sodium sulfate with a concentration of 50 mM was used as supporting electrolyte. Constant current was provided by an Agilent E3612A DC power supply.

Model organic pollutants were added to the electrolyte to obtain solutions with different initial concentrations. The electrochemical process was initiated by starting the DC power supply. At set intervals, samples were taken to analyze the concentration of organic contaminants.

### Self-Cleaning of Organic Compounds by Electrochemical Methods

In some embodiments, the present disclosure relates to a system for electrochemical regeneration method of GAC, such as dye-loaded GAC. The disclosed GACSS cathode is capable for simultaneous H₂O₂ electrogeneration from in situ supplied anodic O₂ and subsequent H₂O₂ activation for OH^{⋅} generation, thus enabling the destruction of dye molecules adsorbed on GAC or within pores and regenerating the GAC.

Saturated granular activated carbon is “self-cleaned” by electrochemical regeneration approach based on its ability on in situ H₂O₂ electrogeneration and activation without any chemicals addition.

### Exemplary Features

(1) The “self-cleaning” electrochemical regeneration process can be operated under mild conditions.

(2) The “self-cleaning” electrochemical regeneration process can be operated without addition of oxidants (i.e., H₂O₂) and catalysts (i.e., Fe²⁺).

(3) The “self-cleaning” electrochemical regeneration process causes the in situ cracking of organics adsorbed on granular activated carbon.

(4) The “self-cleaning” electrochemical regeneration process does not damage the textural characteristics of granular activated carbon.

### Exemplary Advantages and Improvements Over Existing Methods, Devices, or Materials

(1) Compared with thermal regeneration, the process is operated under mild conditions and causes the in situ cracking of organics.

(2) Compared with regeneration by Fenton reagents (Fe²⁺/H₂O₂), no H₂O₂ or Fe²⁺ is required.

(3) Compared with microwave treatment, the process does not require complex microwave generator and high energy consumption.

(4) Compared with conventional electrochemical regeneration where granular activated carbon is put between anode and cathode, granular activated carbon is used as cathode (negatively polarized), thus avoiding the oxidative changes.

### Exemplary Commercial Applications

(1) The cathode configuration and the reactor configuration, which can achieve the “self-cleaning” electrochemical regeneration of organics-saturated granular activated carbon, can be easily scaled-up and has potential to be commercialized.

(2) The proposed method and reactor configuration can also be commercialized for organic contaminants adsorption and in situ degradation.

### Technical Description

Preparation of materials. Granular activated carbon (4-8 mesh) was washed thoroughly by DI water to remove impurities before use. Ti/mixed metal oxides (MMO) mesh was used as anode materials.

Saturation of granular activated carbon. 1.5 g granular activated carbon was firstly saturated with model organic contaminants reactive blue 19 (RB19, with initial concentration of 100 mg/L) in a batch reactor (volume of 180 mL). The reactor was stirred at a constant speed of 350 rpm for 300 min at room temperature. After adsorptive equilibrium was reached, the granular activated carbon was separated from the solution.

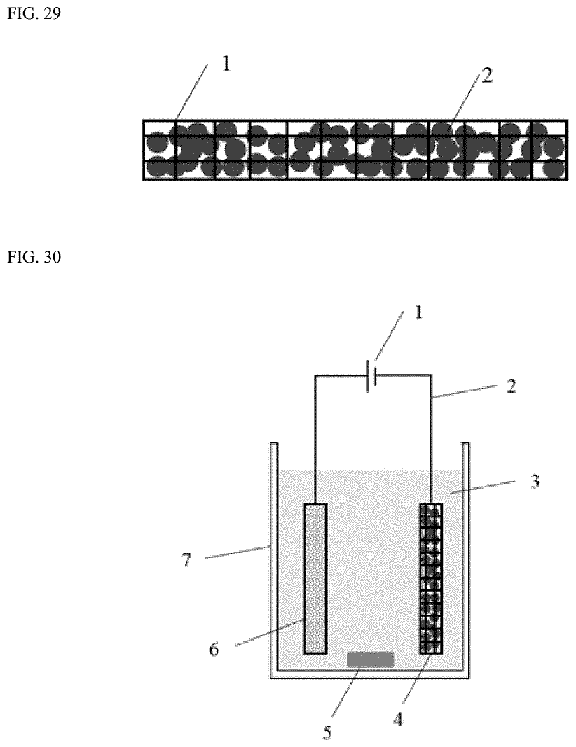

Fabrication of cathode with saturated granular activated carbon. Firstly, a 50×50 stainless steel (SS) mesh bag (2 cm×3 cm) was prepared. Secondly, the SS mesh bag was filled with the prepared saturated granular activated carbon tightly (FIG. 29). The composite electrode was used as an integrated cathode in the “self-cleaning” electrochemical regeneration process.

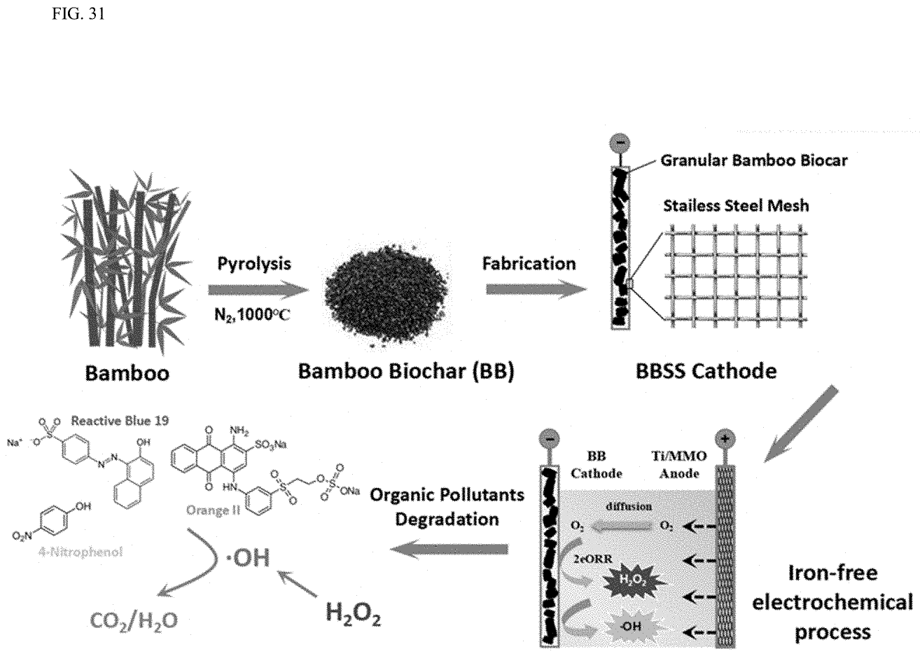

Operation of “self-cleaning” electrochemical regeneration. The regeneration of saturated activated carbon was operated in the same reactor without addition of H₂O₂ and Fe²⁺ (FIG. 31). Sodium sulfate with a concentration of 50 mM was used as supporting electrolyte. Oxygen was in situ supplied by the Ti/MMO anode via oxygen evolution reaction. The distance between anode and cathode is 3.5 cm. Constant current was provided by a DC power supply. The regeneration process was initiated by starting the DC power supply. Various duration, such as 30 min, 180 min, 720 min, were operated.

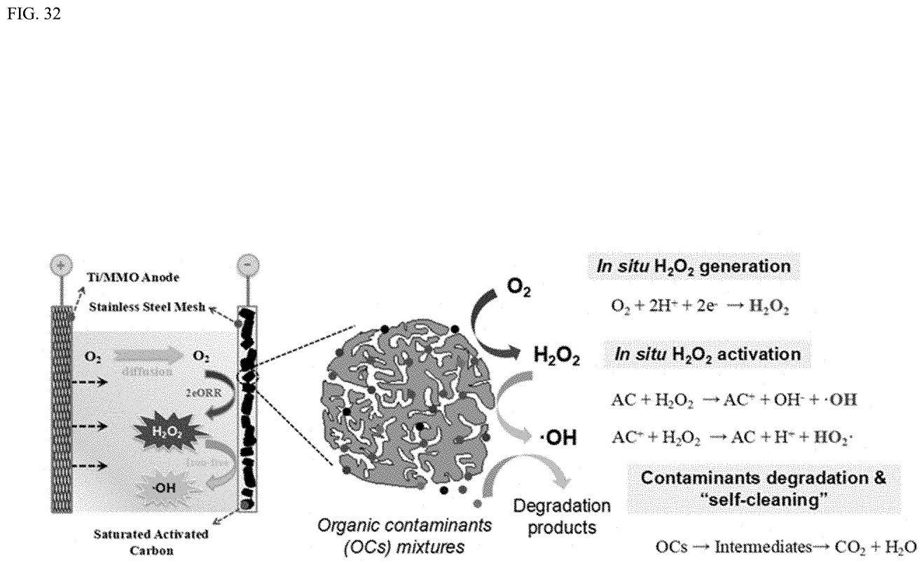

Mechanism of “self-cleaning” electrochemical regeneration. O₂ is generated on the Ti/MMO surface and transported to composite cathode vicinity. The H₂O₂ can be generated from the O₂ electroreduction by activated carbon. As an activator of H₂O₂, activated carbon can decompose H₂O₂ to highly oxidative hydroxyl radicals both inside porous activated carbon or surface. The adsorbed organic contaminants can thus be degraded by hydroxyl radicals and achieve the regeneration of activated carbon (FIG. 32).

Reactor Systems for Electrogeneration on Reactive Oxygen Species without External Oxygen Supply

In some embodiments, the present disclosure relates to flow-through reactors and methods of using them to produce H₂O₂ in a continuous fashion, collecting the product discharge with the outflow. The throughput and concentration of production can be easily and quickly adjusted to meet requirements. Advantageously, any carbon-based hydrophobic electrodes can be used in the reactors.

Advantages of the disclosed reactor and methods include:
no external O₂ and H₂ supply are needed, no catalyst is needed,
there is only one chamber in the reactor, which does not need ion-exchange membrane,
no pretreatment, such as pH adjustment, is required.

Each of these improvements lowers the cost and broadens the application of the reactor. Moreover, because the reactor does not require an external gas supply, the safety factor during operation is increased.

Commercial applications of the technology include production of hydrogen peroxide for medical use (3% H₂O₂ is widely used for disinfection), in situ groundwater and wastewater treatment, portable purified water systems, drinking water cleaning for private home use, and cleaning products for private home or public use.

### Cathode Modification

Two carbon-PTFE O₂ diffusion electrode materials were chosen to use in this reactor. One electrode consisted of a PTFE covered carbon cloth purchased from Fuel Cell Store, and the other consisted of a PTFE covered graphite felt (GF) made in the lab. The graphite felts (Fuel Cell Store) were degreased in an ultrasonic bath with acetone and deionized water for 1 h and dried at 80° C. for 24 h. It was marked as unmodified GF. 60% of PTFE (0.25 mL-1 mL) and 3.25 mL deionized water were mixed for 10 mins in the ultrasonic bath to make a well-dispersed mixture. Then, the pretreated GFs were immersed in this mixture. After drying at 80° C. for 24 h, all samples were annealed at 350° C. for 1 h. Since the volume of PTFE to water in the mixture is 1:13, 1:6.5, 1:4.3 and 1:3.25, the PTFE covered GF were marked as, GF-(1:13), GF-(1:6.5), GF-(1:4.33) and GF-(1.3.25).

### Two-Electrode System

The two-electrode flow-through reactor was a vertical acrylic column with 4.5 cm inner diameter and 15 cm length. Two electrodes were installed in sequence as anode and cathode from bottom to top, and connected to a DC source. Ti-based mixed metal oxide (Ti/MMO) and carbon-PTFE O₂ diffusion electrode were used as the anode and cathode separately. The H₂O₂ electrogeneration experiments were performed in simulated groundwater (3 mM Na₂SO₄ and 0.5 mM CaSO₄) solution at room temperature. Water can be oxidized at the anode surface to produce oxygen. Then, the O₂ raised to the cathode and reduced to H₂O₂ (eq 1) which flows out with the effluent at the top of the reactor.

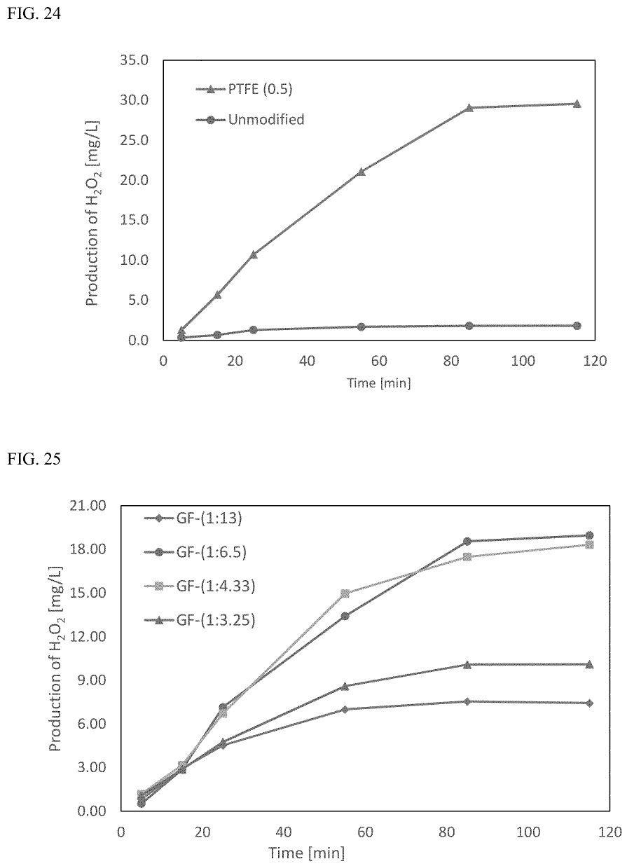

FIG. 24 shows that PTFE coated GF produces about 30 mg/L H₂O₂, which is 16 times more than unmodified GF under flow condition at the same current. PTFE coated GF has high hydrophobicity, which allows the oxygen gas bubble to diffuse through porous structure in the cathode. It extends the reaction time so the production increased.

The production of H₂O₂ by GF-(1:13), GF-(1:6.5), GF-(1:4.33) and GF-(1.3.25) was 7.4 mg/L, 19 mg/L, 18.3 mg/L and 10.01 mg/L respectively (FIG. 25). Under the same condition, with the increase of PTFE, the hydrophobicity of the electrode can increase which can enhance the gas dispersion in electrode. However, too much PTFE covering the surface of GF may decrease the active site on GF, then it can decrease the H₂O₂ production. Thus, GF-(1:6.5) was chosen to use in the future test.

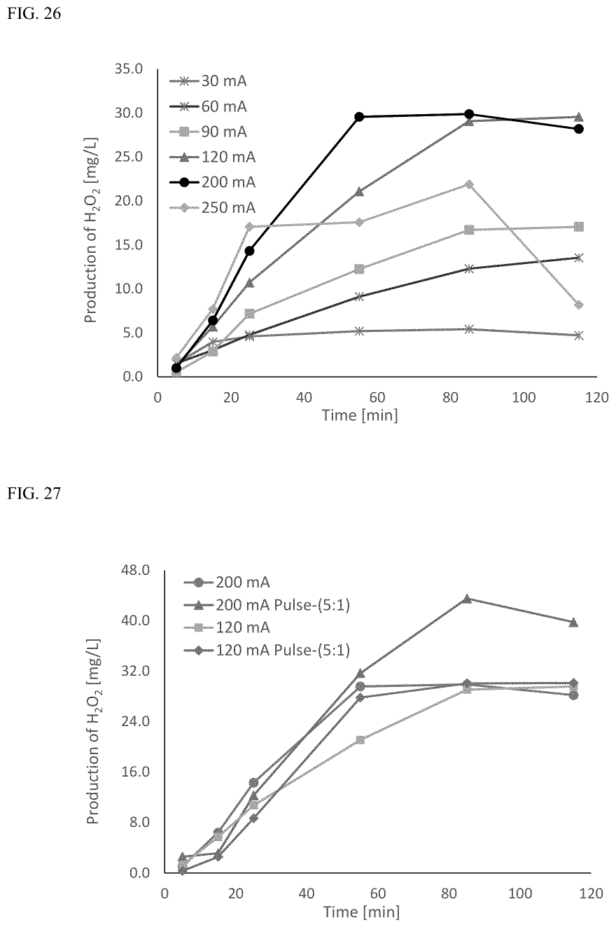

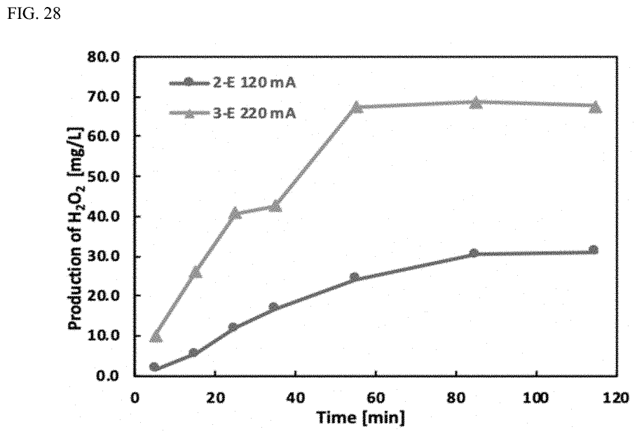

The effect of current on H₂O₂ production was shown in FIG. 26. Under 0.19 cm/min flow rate, increasing current from 30 mA to 120 mA, H₂O₂ production increased from 4.7 mg/L to 28.1 mg/L. At current values over 120 mA the production started decreasing. It is because under lower current, increase current can increase the oxygen production at Ti-MMO anode, which enhanced production. However, with further increasing current, the formed 14202 started to decompose at the cathode, which makes the production stop increasing and even decreae at very high current (250 mA). To solve the decomposition problem, a pulsed current (5 min running with 1 min stop) was used under higher current condition. FIG. 27 shows that under 120 mA, pulse current did not improve the production, however, under 200 mA, the production increased from 28.9 to 39.2 mg/L. This result proves that pulse current condition gives more time for 14202 to disperse from cathode to solution, which decrease the decomposition of H₂O₂ at the cathode, finally increase the production at effluent.

### Three-Electrode System

A three-electrode system was designed to keep increasing the 14202 production. Compared to the two-electrode system, the three-electrode system contains one more cathode (Ti-MMO) located under the anode. This design can efficiently decrease the 14202 decomposition phenomenon. The Ti-MMO cathode can split the current applied on carbon-PTFE O₂ diffusion cathode without changing the current at the anode. For example, the total current applied on anode is 220 mA, in order to keep the current at carbon-PTFE O₂ diffusion cathode still at 120 mA, the other Ti-MMO can split 100 mA. This experiment was marked as 3-E 220 mA. Compared to the two-electrode system (30 mg/L), three-electrode system yielded 70 mg/L of the H₂O₂ production.

In some embodiments, the present disclosure relates to a method of removal of an organic pollutant from an aqueous solution, comprising:

a) contacting the aqueous solution with an anode and a cathode comprising a carbon material;
b) applying electrical current to the anode, thereby generating reactive oxygen species;
b) oxidizing the organic pollutant with the reactive oxygen species; and
c) regenerating the carbon material.

In some embodiments, the carbon material is activated carbon. In some embodiments, the carbon material is biochar, such as a bamboo-derived biochar.

In some embodiments, the cathode comprises a carbon material enclosed in a liquid-permeable membrane. In some embodiments, the liquid-permeable membrane is a stainless steel mesh.

In some embodiments, the cathode contains activated carbon or biochar, wherein the activated carbon or the biochar is enclosed a stainless steel mesh.

In some embodiments, pH of the aqueous solution is from about 3 to about 8, such as about 3, about 4, about 5, about 6, about 7, or about 8.

In some embodiments, the aqueous solution does not comprise Fe²⁺.

In some embodiments, the cathode does not comprise a binder.

In some embodiments, the reactive oxygen species is H₂O₂.

In some embodiments, the present disclosure relates to a method of producing reactive oxygen species, comprising:

a) flowing a precursor solution through a reactor comprising at least one cathode and at least one anode;
b) applying electrical current to the at least one anode; and
c) collecting a product solution comprising reactive oxygen species.

In some embodiments, the reactor is a first vertical tube comprising a first anode attached at the bottom of the tube and a first cathode attached at the top of the tube. In some embodiments, the reactor is a second vertical tube comprising a second cathode attached at the bottom of the tube, a second anode attached above the second cathode at the bottom of the tube, and a third cathode attached at the top of the tube.

In some embodiments, the cathode is an oxygen diffusion electrode. In some embodiments, the oxygen diffusion electrode comprises a carbon-polytetrafluoroethylene (PTFE) material. In some embodiments, the carbon-PTFE material is PTFE-covered carbon cloth or PTFE-covered graphite felt.

In some embodiments, the anode comprises Ti-based mixed metal oxide (Ti/MMO).

In some embodiments, the electrical current is turned off every 2 to 10 minutes, and then turned on after 1 to 3 minutes.

In some embodiments, the reactive oxygen species is H₂O₂.

### EXAMPLES

### Materials

Granular activated carbon (GAC, 4-8 mesh, 4.75-2.36 mm) was purchased from Calgon Carbon Corporation and washed thoroughly with ultra-pure water to remove impurities before use. The GAC has a conductivity of 0.40 S/m, it has an elemental composition of carbon, hydrogen, nitrogen, sulfur, and oxygen of 91.44, 0.91, <0.30, 0.07, and 4.34% by weight, respectively, and 0.28% ash by weight on dry basis. The Brunauer-Emmet-Teller (BET) surface area and micropore volume were found to be 840.5 m²/g and 0.36 cm³/g, respectively.

Ti/mixed metal oxide (MMO, 3N International) mesh was used as anode materials. The Ti/MMO electrode consists of IrO₂ and Ta₂O₅ coating on titanium mesh. The mesh dimensions are 3.6 cm diameter and 1.8 mm thickness. All other reagents used in this experiment are of analytical grade and used without further purification.

Sodium sulfate (anhydrous, Na₂SO₄, ≥99%), titanium sulfate (Ti(SO₄)₂, 99.9%), and hydrogen peroxide (H₂O₂, 30% wt) were purchased from Fisher Scientific. Reactive Blue 19 (C₂₂H₁₆N₂Na₂O₁₁S₃, RB19, 99.9%) was purchased from Sigma-Aldrich. Deionized water (18.2 MΩ cm) obtained from a Millipore Milli-Q system was used in all the experiments. Solution pH was adjusted by sulfuric acid (98%, JT Baker) and sodium hydroxide (Fisher Scientific). A stainless steel (SS) mesh (mesh size is 50 per inch, wire diameter is 0.35 mm, grade 304) was used as the current distributor in BBSS composite electrode.

Fresh bamboo was collected from a local bamboo grove in Nansha District, Guangzhou, China. The bamboo stem was cut into small pieces (4-8 mesh, 4.75-2.36 mm) and thoroughly rinsed with DI water. After drying at 80° C., the bamboo stem pieces were pyrolyzed in a tubular furnace at 1000° C. for 3 hours under the protection of N₂ atmosphere. Thereafter, the temperature decreased to 300° C. at 5/min and finally decreased naturally to room temperature. The resulting bamboo biochar was washed in 5 M HCl solution for 3 hours before characterization.

### Example 1. Cathode Fabrication, Modification of BB

An SS mesh bag (2 cm×4 cm) was prepared and filled with 2.0 g granular BB. The SS mesh bag was tightly filled so that the SS mesh had good contact with the BB. The Ti/MMO electrode was used as an anode to generate O₂ that could be used by the BBSS cathode for H₂O₂ electrogeneration. Ti/MMO anode and BBSS cathode were arranged in a batch reactor (volume 180 mL) horizontally with a distance of 3 cm. 50 mM Na₂SO₄ was used as supporting electrolyte. Constant current was provided by an Agilent E3612A DC power supply.

Electrochemical modification of the as-prepared BB was conducted in 50 mM Na₂SO₄ electrolyte in the same batch reactor. The BBSS electrode served as an anode while the Ti/MMO electrode served as a cathode. A constant current of 200 mA and was applied for 30 min. Evaluation of the catalytic activity of BBSS electrodes on Na₂SO₄ activation was conducted by adding 2.0 g BB to a batch reactor under different initial pH and H₂O₂ concentrations. The degradation of RB19 by EF-like process was carried out in the same apparatus under neutral initial pH and initial RB19 concentrations of 34.8, 17.4, and 10.4 mg/L. The above fabrication process of BBSS electrode and EF-like system is shown in FIG. 29.

### Example 2. Electro-Fenton Like Operation

H₂O₂ concentration was measured at 405 nm on a Shimadzu UV-Vis spectrometer after coloration with Ti(SO₄)₂. RB 19 concentration was determined on the same spectrophotometer at 594 nm. The total organic carbon (TOC) concentration was determined using a TOC analyzer (TOC-V, Shimadzu). The conductivity of electrolyte was measured using conductivity meter (Fisher Scientific). The removal efficiency of model organic pollutants and TOC were calculated using Eq. 10, where C₀ and Cₜ are the concentration of pollutants or TOC at time zero and time t, respectively.

$$η = \frac{{C}_{0} - {C}_{t}}{{C}_{0}} \times 100 \% \qquad ( 10 )$$

Solution pH was measured by pH meter (Thermo Scientific). The concentration of OH^{⋅} was evaluated by using benzoic acid (BA) as a trapping reagent. BA has a high second-order rate constant with OH^{⋅} (4.2×109 M-1 s-1) and can be used for semi-quantitative determination of OH^{⋅}. In this work, the fluorescence intensity of the product was measured by fluorescence spectrophotometer (Shimadzu XRF-1800 or Shimadzu RF-5001) at the excitation wavelength of 303 nm.

The O₂ theoretical production (OTP) was calculated using the Eq. 11, where I is anode current (A), t is the time (s), F is the Faraday constant, n is the electron umber of oxygen evolution reaction (n=4), Vₜ is molar gas volume at 25° C. (24.5 L/mol). The O₂ utilization efficiency (OUE) was then calculated using the Eq. 12, where n(O₂, OTP) is the amount of O₂ theoretical production in moles, n(O₂, 2e⁻ reduction) is the amount of O₂ that is used for H₂O₂ production, which is the same value of H₂O₂ production in moles.

$$\begin{matrix}OTP = \frac{{\int }_{0}^{t} Idt}{nF} \times {V}_{t} & ( 11 ) \\ OUE = \frac{n ( {O}_{2} , 2 {e}^{-} reduction )}{n ( {O}_{2} , OTP )} \times 100 \% & ( 12 )\end{matrix}$$

The faradic current efficiency (CE) of H₂O₂ electrogeneration was calculated using the Eq. 13, where n is the number of electrons required for O₂ reduction to H₂O₂, F is the Faraday constant (96485.3 C/mol), C_{H2O2} is the concentration of H₂O₂ (mol/L), V is the solution volume (L), I represents applied current intensity (A), and t is the time (s).

$$CE = \frac{{nFc}_{{H}_{2} {O}_{2}} V}{{\int }_{0}^{t} Idt} \times 100 \% \qquad ( 13 )$$

GAC regeneration efficiency (RE) was calculated using Eq. 14, where q_{e,o} and q_{e,r} denote the adsorption capacity of original and regenerated GAC, respectively.

$$RE = \frac{{q}_{e , r}}{{q}_{e , o}} \times 100 \% \qquad ( 14 )$$

The surface morphology of the original, saturated, and regenerated GAC were characterized with SEM (Hitachi SU-8000). The surface area and pore volumes of GAC was examined by an automatic N₂ adsorption instrument (ASAP 2420 V2.05). The conductivity of the GAC was measured using digital Multi-meter (Keithley 2700 Bench Digital Multimeter).

### Example 3. Characterization of Bamboo Biochar

The surface morphology of the resulting biochar was observed by scanning electron microscopy (SEM, ZEISS-Merlin). Raman measurement was performed using a Renishaw inVia Micro-Raman spectrometer with 532 nm diode laser excitation. FTIR (Bruker Vector 33) and X-ray photoelectron spectroscopy (XPS, PHI 5700 ESCA system) were employed to identify the functional groups on the biochar surface. Prior to FTIR analysis, the sample was dried at 70° C. overnight. The FTIR spectra in the range of 500-4000 cm-1 were obtained by mixing biochar with spectroscopic grade KBr (biochar/KBr ratio: 1:100) and compressing the mixture into pellets. X-ray diffraction pattern (XRD) was obtained using a Rigaku D/max-3A diffractometer operating with a Cu Kα (λ=1.541 nm) radioactive source in the scan range of 5° to 90°. N₂ adsorption/desorption isotherms of the biochar was measured at −196° C. using an ASAP 2420 V2.05 apparatus. The total pore volume (Vₜₒₜₐₗ) was estimated from the N₂ amount adsorbed at relative pressure of 0.975. The Brunauer-Emmet-Teller specific surface area (S_{BET}) was calculated from the isotherm using the BET equation. The micropore volume (V_{mic}) and surface area (S_{mic}) were calculated by the t-plot method. The average pore size (Dₐᵥₑ) was calculated from the measured values of S_{BET} and Vₜₒₜₐₗ. The pore size distribution was determined using the nonlocal density functional theory (NLDFT) by the adsorption branch.

Linear sweep voltammetry (LSV) and chronoamperometry (CA) techniques were carried out on a SP-300 electrochemical workstation (BioLogic, France) to evaluate the BBSS electrode for H₂O₂ generation via O₂ reduction reaction and its long-term stability. The prepared BBSS electrode was used as the working electrode, a platinum plate (1 cm×1 cm) as counter electrode and a Ag/AgCl electrode as the reference electrode.

TABLE 3
Pore structure parameters of bamboo biochar.

| S_{BET} (m²/g) | S_{mic} (m²/g) | Vₜₒₜₐₗ (cm³/g) | V_{mic} (cm³/g) | Dₐᵥₑ (nm) |
|---|---|---|---|---|
| 80.9 | 79.3 | 0.0432 | 0.0408 | 1.99 |

### Example 4. Adsorption Experiments and Regeneration of RB19-Loaded GAC

Reactive blue 19 (RB19) was used as a model organic contaminant and its adsorption on GAC was conducted using a batch reactor. 1.5 gram of GAC (virgin or regenerated) was added to the batch reactor that contained 180 mL of RB19 solution with an initial RB19 concentration of 500 mg/L. The reactor was then stirred at a constant speed of 350 rpm for 6 h. After adsorptive equilibrium was reached, the GAC was separated from the solution. Before analysis of the residual RB19 concentration, the solution was filtered through a 0.45 μm filter.

The regeneration of RB19-saturated GAC was conducted in an undivided electrochemical cell without addition of H₂O₂ and Fe²⁺. Na₂SO₄ solution (50 mM) was used as a supporting electrolyte. O₂ was in situ supplied by Ti/MMO anode via oxygen evolution reaction (OER). The cathode consisted of a 50×50 stainless steel mesh bag (SS mesh bag, 2 cm×3 cm×3 mm) filled with 1.5 g RB19-loaded GAC (denoted as GACSS cathode). SS mesh bag was filled tightly with GAC, thus GAC could conduct electricity and serve as part of the cathode. The distance between two electrodes was 3.5 cm. Constant current of 100 mA was provided by an Agilent E3612A DC power supply.

All U.S. patents and U.S. and PCT patent application publications mentioned herein are hereby incorporated by reference in their entirety as if each patent or publication was specifically and individually indicated to be incorporated by reference. In case of conflict, the present application, including any definitions herein, will control.

While specific embodiments of the subject invention have been discussed, the above specification is illustrative and not restrictive. Many variations of the invention will become apparent to those skilled in the art upon review of this specification and the claims below. The full scope of the invention should be determined by reference to the claims, along with their full scope of equivalents, and the specification, along with such variations.

What is claimed is:

1. A method of removal of an organic pollutant from an aqueous solution, comprising:
a) contacting the aqueous solution with an anode and a cathode comprising a carbon material;
b) applying electrical current to the anode, thereby generating reactive oxygen species;
b) oxidizing the organic pollutant with the reactive oxygen species; and
c) regenerating the carbon material.

2. The method of claim 1, wherein the carbon material is activated carbon.

3. The method of claim 1, wherein the carbon material is biochar.

4. The method of claim 3, wherein the biochar is a bamboo-derived biochar.

5. The method of claim 1, wherein the cathode comprises a carbon material enclosed in a liquid-permeable membrane.

6. The method of claim 5, wherein the liquid-permeable membrane is a stainless steel mesh.

7. The method of claim 1, wherein the cathode contains activated carbon or biochar, and the activated carbon or the biochar is enclosed in a stainless steel mesh.

8. The method of claim 1, wherein the pH of the aqueous solution is about 3 to about 8.

9. The method of claim 1, wherein the aqueous solution does not comprise Fe²⁺.

10. The method of claim 1, wherein the cathode does not comprise a binder.

11. The method of claim 1, wherein the reactive oxygen species is H₂O₂.

12. A method of producing reactive oxygen species, comprising:
a) flowing a precursor solution through a reactor comprising at least one cathode and at least one anode;
b) applying electrical current to the at least one anode; and
c) collecting a product solution comprising reactive oxygen species.

13. The method of claim 12, wherein the reactor is a first vertical tube comprising a first anode attached at the bottom of the tube and a first cathode attached at the top of the tube.

14. The method of claim 12, wherein the reactor is a second vertical tube comprising a second cathode attached at the bottom of the tube, a second anode attached above the second cathode at the bottom of the tube, and a third cathode attached at the top of the tube.

15. The method of claim 12, wherein the cathode is an oxygen diffusion electrode.

16. The method of claim 15, wherein the oxygen diffusion electrode comprises a carbon-polytetrafluoroethylene (PTFE) material.

17. The method of claim 16, wherein the carbon-PTFE material is PTFE-covered carbon cloth or PTFE-covered graphite felt.

18. The method of claim 12, wherein the anode comprises Ti-based mixed metal oxide (Ti/MMO).

19. The method of claim 12, wherein the electrical current is turned off every about 2 to 10 minutes, and then turned on after about 1 to 3 minutes.

20. The method of claim 12, wherein the reactive oxygen species is H₂O₂.
